(19) United States
(12) Patent Application Publication
(10) Pub. No.: US 2007/0044527 A1
(43) Pub. Date: Mar. 1, 2007

(54) Beneficial source separated organics products

(76) Inventors: Rae E. Wallin, Maitland (CA); Grant H. Mills, Mississauga (CA)

Correspondence Address: MANELLI DENISON & SELTER, 2000 M STREET NW SUITE 700, WASHINGTON, DC, 20036-3307, US

(21) Appl. No.: 11/475,219

(22) Filed: Jun. 27, 2006

(30) Foreign Application Priority Data
Aug. 26, 2005 (CA) 2,517,320

(51) Int. Cl. C05F 9/00

(52) U.S. Cl. 71/14

(57) ABSTRACT

A method of producing a beneficial source separated organics waste mixture which method includes mixing source separated organics waste cake and an effective amount of alkaline dust to form a composite mixture having a pH of at least 12 for at least 72 hours at a temperature selected from 52-62° C. for at least 12 hours; and collecting the beneficial source separated organics waste mixture. The product can be directly applied to agricultural lands to provide macronutrients and as a soil conditioner. Preferably, the source separated organics is kitchen waste.

### FIELD OF THE INVENTION

This invention relates to a method of beneficiating source separated organics, particularly, kitchen waste with an alkaline dust, product made therefrom, and use of said product as a fertilizer and soil conditioner.

### BACKGROUND OF THE INVENTION

The term “source separated organics” is a term in the art and includes kitchen waste from households and restaurants, businesses, such as food processing plants generally resulting from physical separation at source in the aforesaid establishment or at city municipal, country and the like public sorting centers. The term embraces articles such as diapers, sanitary articles and other fiber materials, which are putrescable, i.e. subject to bacterial decomposition; but not organic wastes such as garden and yard wastes.

Municipal curb-side pick-up of kitchen waste is a common practice in many rural and urban communities. A major desired goal of such services is to generate resultant useful product materials, particularly from the organic matters contained in the kitchen waste. However, prior art processes to convert this waste into a useful product are meeting very limited success.

Typical prior art composting processes using these wastes having potentially high nutrient content, however, involve significant disadvantages. One main problem results from the exothermic composting reaction getting out of control and generating excessive heat, which stops the microbial composting activity. A further problem occurs, even under simple storage, in the generation of obnoxious odors to provide a major public nuisance. Further, many kitchen waste streams have physical characteristics that are not well suited for bulk compost procedures.

Historically, the stabilization of many organic waste streams has been achieved through composting. In this process, nutrients are metabolized by microflora and converted to either complex biomass (the microflora themselves) or completely respired to carbon dioxide. Optimizing the composting process is complex and requires the balancing of pH, moisture, temperature, aeration and nutrient balance to maintain conditions for efficient and controlled microfloral growth and metabolism. Too rapid metabolism leads to excessive heat generation, which can inhibit and even kill the microflora metabolizing the nutrients. Similarly, excessive respiration can generate anaerobic conditions that can lead to growth of different species of microflora, which typically utilize the nutrients more slowly. A number of studies have shown that the addition of N-Viro Soil (NVS) to composting reactions of a number of organic wastes containing high levels of cellulose (yard wastes and various manures) can facilitate the composting process. The rationale for the effects of NVS addition to composting reactions are thought to center around: 1) the buffering capacity of the NVS, 2) the low-level of nitrogen added into the reaction, 3) the physical characteristics of the mixed material, demonstrating increased aeration and water-shedding capability, 4) the odor-controlling characteristics of NVS, 5) the disinfecting capability of NVS (limiting the growth of Salmonella), and 6) the populations of microflora conditioned to NVS that are introduced into the reaction. While not making the co-composting reaction completely self-regulating, the addition of NVS to composting materials is seen to enhance the rate of compost maturing, facilitate product handling and storage, and odor control during processing.

Typical curb-side pick-up of kitchen waste, typically in garbage bags, involves the transportation of the kitchen waste to a municipal or private receiving station, where the garbage bags are mechanically shredded and the contents slurried with water. The lighter materials, such as plastic materials which float, are skimmed or decantered off, while the heavy particles, such as grit, metal pieces and the like fall to the bottom of the receiving tank. The resultant fine slurry is then dewatered by screw-pressing, centrifugation or the like, and provides a dewatered fine solids cake which, typically, contains 50-80% w/w volatile solids subject to microbial action in the composting reaction.

The present treatment of this solids cake involves, generally, either leaving it to compost on the fields, or transporting it to landfill sites. These techniques are most unsatisfactory in that the composting is not sufficiently efficacious, allows of obnoxious smells to permeate the sites, and is costly in being labour intensive because of the need for very frequent in-situ mechanical turning of the cake with bulldozers, scarabs or the like. Further, any beneficial resultant product is not properly utilized.

U.S. Pat. No. 4,554,002, issued Nov. 19, 1985, U.S. Pat. No. 4,781,842, issued Nov. 1, 1988, and U.S. Pat. No. 4,902,431, issued Feb. 20, 1990, all to N-Viro Energy Systems Ltd., Ohio, U.S.A. as assignee, describes the preparation of a disintegratable, friable product for use as a soil conditioner or fertilizer. The product is made by beneficiating wastewater sludge, and other human, animal and poultry manures, to eliminate pathogens. The processes comprise mixing the sludge or the manures with kiln dust to form a mixture, of from about 10% to about 30% w/w kiln dust and from about 90% to about 70% w/w waste water sludge, wherein the amount of kiln dust is sufficient to raise the temperature of the mixture to between 52 and 62° C., and maintain thereat for 12 hours; and raise the pH to at least 12 and maintain thereat for 72 hours. The resultant product of this treatment is to produce an acceptable soil conditioner and partial fertilizer by eliminating or significantly reducing undesirable characteristics of each material if each were to be used separately.

However, there remains a need for producing a beneficial product out of kitchen wastes which generally contain, unlike waste water treated sludge, a variety of disparate materials, noxious and otherwise.

### SUMMARY OF THE INVENTION

It is an object of the present invention to provide a beneficial material suitable for application to land as a fertilizer and soil conditioner, from source separated organics, particularly, kitchen waste.

It is a further object to provide a process for the production of aforesaid product.

Accordingly, in one aspect, the invention provides a method of producing beneficial source separated organics waste mixture, which method comprises mixing source separated organics waste cake and an effective amount of alkaline dust to form a composite mixture having a pH of at least 12 for at least 72 hours at a temperature of 52-62° C. for 12 hours; and collecting an initial said beneficial source separated organics waste mixture.

The alkaline dust is preferably selected from, but not limited to, lime, fly ash, cement kiln dust and lime kiln dust, most preferably cement kiln dust or lime kiln dust. The processes as hereinabove defined are carried out to obtain mixtures having a preferred dryness of 60 to 65% solids.

Preferably, the source separated organics waste is kitchen waste.

In a preferred aspect, the invention provides a method of treating source separated organics waste cake containing odorous materials, animal viruses, pathogenic bacteria, and parasites to provide a fertilizer for agricultural lands which can be applied directly to the lands, which method comprises:—

mixing the source separated organics waste cake with at least one alkaline material selected from the group consisting of fly ash, lime, cement kiln dust and lime kiln dust to form a mixture wherein the amount of added alkaline material mixed with the cake is sufficient to raise the temperature and pH of the mixture to the aforesaid desired levels;

drying the mixture to produce a granular material; and

wherein the amount of added alkaline material mixed with the cake and the length of time of drying said mixture is sufficient to (i) reduce significantly offensive odor of the cake to a level that is tolerable; (ii) reduce enterovirus therein to less than one plaque forming unit per 4 g dry-weight solids (DWS) of the cake; (iii) reduce fecal coliform bacteria therein to less than 1000 MPN per 1 g DWS; (iv) reduce salmonella to less than 3 MPN per 4 g DWS; (v) reduce parasites therein to less than one viable egg per 1 g DWS; (vi) reduce vector attraction to the cake; and (vii) prevent significant regrowth of the pathogenic microorganisms.

Preferably, the source separated organics waste is kitchen waste.

Thus, the amount of added alkaline material mixed with the cake and the length of time of drying is sufficient to reduce the odor to a level that is tolerable in a closed room even though the pH may drop below 9 during the drying, and maintain that odor control indefinitely even though said mixture is exposed to climatic conditions.

Preferably, the added alkaline material comprises kiln dust and the amount of added material comprises about 35% by weight of the cake to reduce the odor to a level that is tolerable in a closed room even though the pH may drop below 9 during the drying, and maintain that odor control indefinitely even though the mixture is exposed to climatic conditions.

Preferably, the drying is by aeration.

In a further aspect, the invention provides a beneficial source separated organics waste mixture product made by a method as hereinabove defined.

Preferably, the beneficial source separated organics waste is kitchen waste.

The mixture is permitted to cure until it is sufficiently cohesive so that it can be readily formed into granulated particles by shredding, crushing or the like. The resultant product is friable so that upon being spread on the ground and exposed to the elements, for example, as in farming, it will break down into small fine particles.

Surprisingly, we have, thus, found that the alkaline-dust mixture product provides an acceptable soil conditioner and partial fertilizer by eliminating or significantly reducing undesirable characteristics of each starting material, if used separately.

We have found that the soil conditioner improves the workability of the soil, which improves the water carrying capacity of the soil and increases the ion exchange capacity of the soil. The partial fertilizer provides macronutrients, such as nitrogen, phosphorous, potassium, calcium, sulfur and magnesium and limited quantities of micronutrients, such as molybdenum, zinc and copper.

Accordingly, in a further aspect, the invention provides a method of improving the workability and enhancing the macronutrient content of soil which method comprises treating said soil with an effective amount of a beneficial source separated organics, preferably, kitchen waste mixture, as defined hereinabove.

### BRIEF DESCRIPTION OF THE DRAWINGS

In order that the invention may be better understood, preferred embodiments will now be described, by way of example only, with reference to the accompanying drawings wherein,

FIG. 1 is a diagrammatic block diagram illustrating the process of making beneficial kitchen waste mixture product, according to the invention;

FIG. 2 is a graph of pH of various mixtures with time;

FIG. 3 is a graph of the percentage solids of various co-composted mixtures against time; and

FIG. 4 is a graph of the volatile organics compounds for various co-composted mixtures against time.

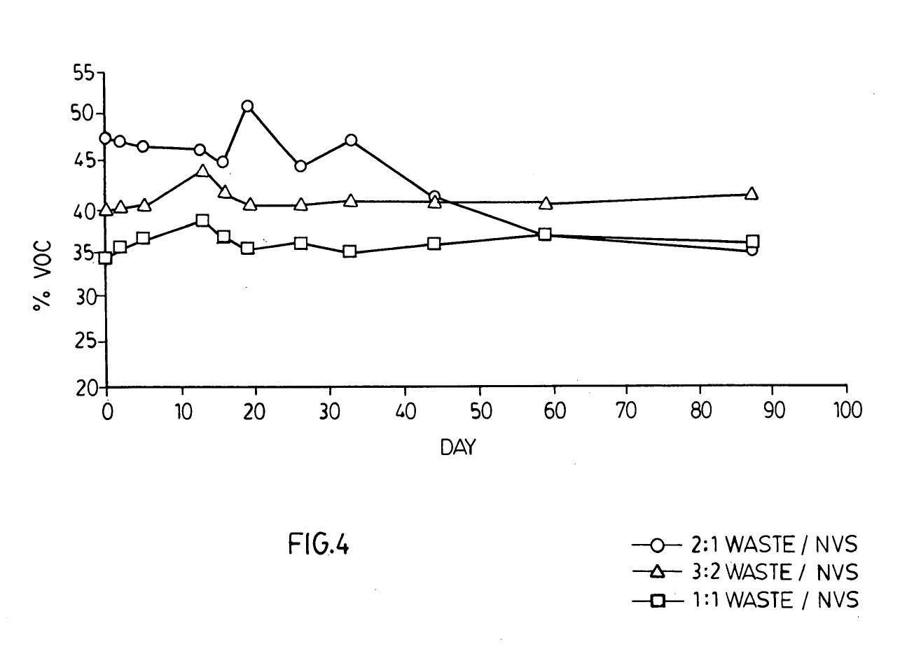

### DETAILED DESCRIPTION OF PREFERRED EMBODIMENTS

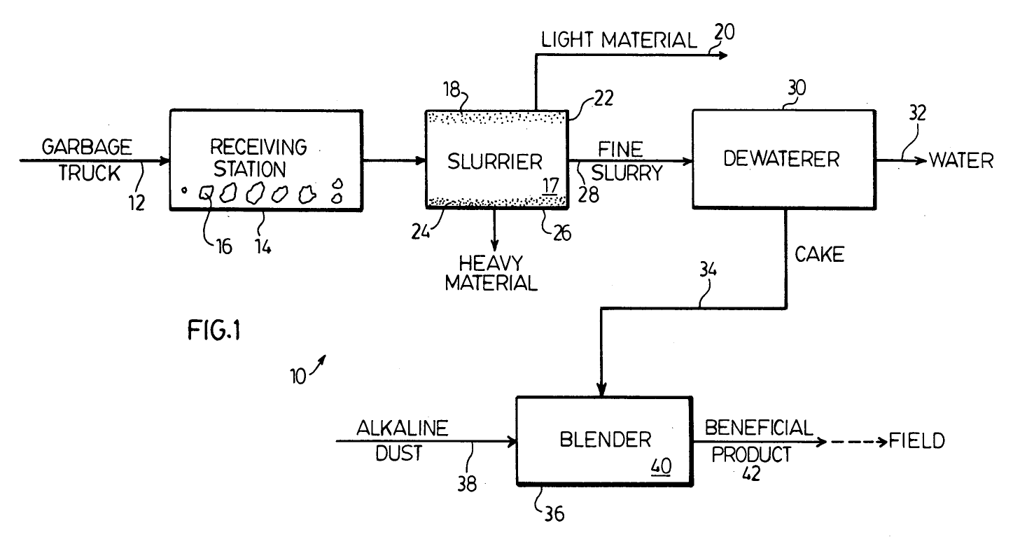

With reference to FIG. 1, this shows generally as 10, a process of making beneficial product from municipal or private garbage bag collection 12 to receiving station 14 wherein bags 16 are mechanically shredded to produce kitchen waste material 17 for slurrying in slurrier 18. Light material 20, such as pieces of plastic, are removed from the upper part 22 of slurrier 18, heavy material 24 from the lower part 26 of slurrier 18 and the remaining fine material as a slurry 28 is pumped to dewaterer 30. Dewaterer 30 may comprise a screw press or centrifuge means (not shown) whereby water 32 is removed to leave kitchen waste fine cake 34. The aforesaid process of producing cake 34 is acknowledged herein to form part of the prior art, wherein the following steps constitute procedures according to the invention.

Cake 34 is transferred to a blender 36 whereby it is combined with alkaline dust 38, kiln dust in this embodiment according to the invention, to form admixture 40 and treated as hereinafter described to produce beneficial kitchen waste mixture product 42.

### EXAMPLES

In these embodiments, de-watered kitchen waste (39% solids) was treated by two processes in an effort to stabilize the nutrients and produce acceptable re-use products. The first process treated the kitchen waste sample in a standard N-Viro Soil Process (herein NVS) and compared to a standard alkaline-stabilization treatment. The second process-used NVS as an ingredient to stabilize and facilitate a co-composting reaction.

The sample under test appeared fibrous with occasional small pieces of plastic. The initial physical characteristics of the sample are presented in Table 1.

Process 1 N-Viro Soil Process and Alkaline Stabilization

Initial studies focused on the physical, chemical, and odor characteristics of the dewatered kitchen wastes treated with an alkaline admixture using laboratory-based alkaline stabilization and the N-Viro Soil processes. An alkaline admixture (cement kiln dust) was added at different amounts to two separate portions of the sample to effect a typical alkaline stabilization [20% CKD: sample (w/w)] and a typical N-Viro Soil Reaction [34% CKD:sample, (w/w), 52-62° C. for 12 hours, pH >12 for 72 hours]. The resulting products were then evaluated for pH, solids, physical characteristics, and odor. The end-products were also evaluated for agronomic value (NPK and CCE) and pathogen reduction (fecal coliforms). The results from these studies are presented in Table 1.

TABLE 1

| | | Alkaline | |
|---|---|---|---|
| | Initial | Stabilization | N-Viro Soil |
| Analysis | Material | (20% CKD) | Process |
| pH | 6.8 | 12.5 | 12.5 |
| % Solids | 39.1% | 51.5% | 59.0% |
| Volatile Solids | 73.8% | 49.4% | 39.4% |
| Fecal Coliforms | | | |
| (MPN/gDWS) | 7.2 × 10⁷ | 1.9 × 10² | <1 |
| CCE | ND^{†} | 29.9% Dry | 44.9% Dry |
| Total Nitrogen | ND | 43.5 lbs/tonDWS | 37.6 lbs/tonDWS |
| Total Phosphorus | ND | 5.4 lbs/tonDWS | 5.5 lbs/tonDWS |
| Total Potassium | ND | 47.4 lbs/tonDWS | 66.8 lbs/tonDWS |
| Physical | | | |
| Characteristics | | | |
| Compactability | Very | Moderate | Moderate |
| Granularity | Fair | Good | Good |
| Stickiness | Very | Moderate | Moderate/Slight |
| Odor | 4.5 | 3.5 | 3 |
| Overall | Poor | Good | Good |

^{†}Not done

The predominant odors associated with each of the CKD-treated samples were ammonia, with some cement and ‘organic’ odors. The odor of the untreated material is quite obnoxious and is similar to ‘used baby diapers.’ The alkaline stabilized product demonstrated a 5-log reduction of fecal coliform levels and would be suitable as a Class B biosolids product. Typically, alkaline treatment alone is not sufficient to effect Class A pathogen reduction levels. The kitchen waste treated with the N-Viro Soil Process had very favorable physical characteristics and would be considered as having reached Class A biosolids level of pathogen reduction. Both CKD-treaded products appear very usable as soil amendments. Subsequent storage of the treated samples demonstrated no discernable changes in overall physical characteristics and the odor decreased markedly over time.

Process II Co-Composting with N-Viro Soil

Initial Mixing and Evaluation

The results herein show the effects of the addition of commercially available NVS to the composting of sample kitchen waste. Three reaction mixtures with different ratios of kitchen waste to NVS (see Table 2) were blended and water was added so that each mixture had approximately 55% moisture, i.e. moisture level needed for active microfloral metabolism. Each reaction mixture was sampled and analyzed for various chemical and physical characteristics (see Table 2). The mixtures were then placed in plastic bags and incubated at 41.5° C. to approximate the temperature conditions inside a composting pile. The present study was originally organized to follow the progression of all 3 reaction mixtures as they were incubated over a 6-week time period. During the course of the study, it became clear that the 3:2 Waste/NVS and the 1:1 Waste/NVS reaction mixtures yielded products that would not be suitable for normal composting, owing to their very poor physical characteristics (see Table 2) and chemical characteristics (see below). While analyzing these reactions during the remainder of the study period and through extended data gathering time, the major focus of the data gathering was on the 2:1 Waste/NVS co-composting reaction.

TABLE 2

| | | Mixing Volume Ratio | | | | | |
|---|---|---|---|---|---|---|---|
| Density | | 2:1 | | 3:2 | | 1:1 | |
| Waste | NVS | Waste (g) | NVS (g) | Waste (g) | NVS (g) | Waste (g) | NVS (g) |
| 0.56 | 0.92 | 850 | 695 | 750 | 818 | 600 | 981 |

| % Solids | | | | |
|---|---|---|---|---|
| Waste | NVS | (Calculated) | (Calculated) | (Calculated) |
| 39.1% | 69% | 52.6% | 54.7% | 57.7% |

| | | | |
|---|---|---|---|
| H₂O needed (ml) | 260.5 | 339.2 | 446.4 |
| Target 45% | | | |
| Total Reaction (g) | 1806 | 1907 | 2028 |
| (ml) | 2887 | 2880 | 2837 |
| Physical | | | |
| Characteristics | | | |
| Color | Light Brown | Light Brown | Light Brown |
| Compactability | Moderate | Very | Very |
| Granularity | Fair | Poor | Poor |
| Stickiness | Very | Very | Very |
| Odor | 3.7 | 4.0 | 4.0 |
| Overall | Poor | Very Poor | Very Poor |

pH

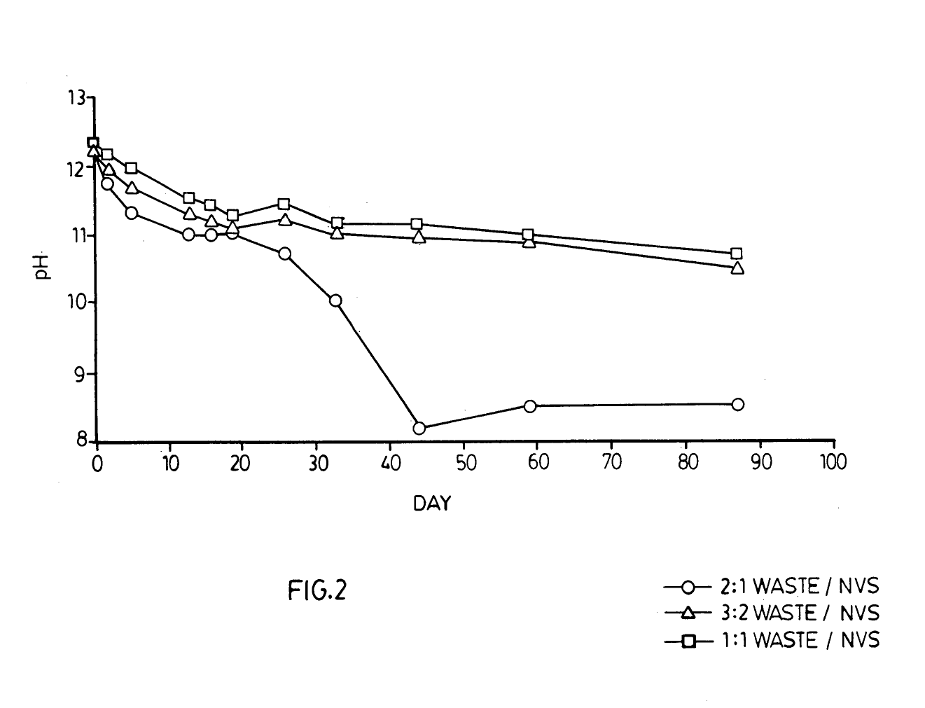

The pH of the mixtures shown in FIG. 2 demonstrated an initial high pH in all the mixtures, due to the high pH (>12) of the NVS added, which then decreased in two weeks to pH levels close to 11.

After further incubation at 41.5° C., the reaction mixture with the least amount of added NVS (2:1 Waste/NVS) dropped to nearly pH 8 (near the buffering point of calcium carbonate in the NVS) and maintained that pH throughout the remainder of the study. The pH's of the other reaction mixtures remained high (above pH 10.5). These results would be consistent with the concept that the biological activity in the 2:1 Waste/NVS mixture led to the production of CO2 and acidic waste products which lowered the pH of the mixture, but only to the point to where the relatively high buffering capacity of the NVS maintained the mixture near pH 8. A pH of 8 is considered in the optimal range for most aerobic composting reactions. Composting systems that are relatively unbuffered can produce acidic pH, which can severely limit ongoing composting activity.

Percent Solids/Physical Characteristics

Periodically, the composting reactions were removed, stirred to aerate and blend the mixtures, sampled, and then water was added to replace moisture lost during the incubation and respiration. The percent solids in the sample mixtures remained relatively constant (FIG. 2). For evaluation of the physical characteristics of reactions at the end of the study, the mixtures were dried to approximately 50% solids (see Table 3). The 2:1 Waste/NVS reaction mixture became more manageable during the course of the reaction, yielding a material though relatively sticky at 50% solids, had a significant decrease in odor and upon further drying could readily be used in normal land-application programs.

TABLE 3

| | |
|---|---|
| Physical | Volume Ratio (Waste/NVS) |

| Characteristic | 2:1 | 3:2 | 1:1 |
|---|---|---|---|
| Color | Light Brown | Light Brown | Light Brown |
| Compactability | Moderate | Very | Very |
| Granularity | Fair | Poor | Poor |
| Stickiness | Moderate | Very | Very |
| Odor | 2.0 | 4.0 | 4.0 |
| Overall | Fair | Very Poor | Very Poor |

Volatile Solids

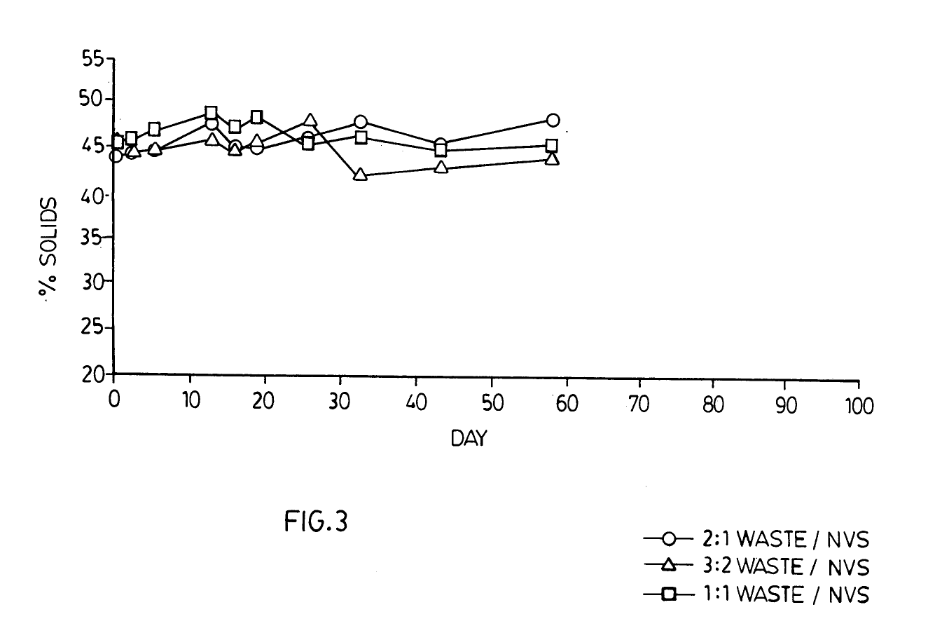

The percent volatile solids in each of the sample mixtures was also measured. A sample's percent volatile solids indicates the percent of the total solids that volatilize when a portion of the sample is heated to over 700° C., and roughly approximates the relative amount of organic matter contained in the sample. Initially, as expected, mixtures with higher Waste:NVS ratio had correspondingly higher percentages volatile solids (47.6%, 39.8%, 34.3% for 2:1, 3:2, and 1:1 Waste/NVS respectively). The reaction with the highest percentage of volatile solids (2:1 Waste/NVS) was shown to have decreasing percentage of volatile solids over time (see FIG. 3), in a timeframe coincident with its decrease in pH (see FIG. 2). These results would indicate that after Day 30 of the study, the microflora were breaking down and mineralizing the volatile solids in this reaction mixture. By Day 90 of the study more than 25% of the volatile solids had been removed by the composting reaction. In previous studies it has been shown that both complex and simple organic compounds are consumed during NVS composting and the remaining organic compounds are more limited in species and may reflect compounds not readily broken down by the microflora responsible for the composting activity.

Additional Parameters

The co-composting reactions were also analyzed for parameters associated with public health (fecal coliform levels) and composting activity (specifically carbon/nitrogen ratio and conductivity). As one would expect from the combined effects of high pH (above pH 12) and elevated temperature (41.5° C.) for extended periods (3 weeks and beyond), the fecal coliform levels in all the reaction mixtures were very low (see Table 3). The data observed for the composting activity yielded conflicting interpretations, however. In previous studies using NVS in co-composting reactions, initial carbon/nitrogen ratios were typically quite high (sometimes over 40) and during the course of the metabolism of the carbon-containing nutrients into biomass, the ratios would decline to approximately 20, often considered optimal for mature composted materials. In the mixtures used in these studies, the initial carbon/nitrogen ratios of the various composting reactions were low, indicating

TABLE 4

| Reaction | | Total | Total | C/N | Conductivity | Fecal Coliforms |
|---|---|---|---|---|---|---|
| (Waste/NVS, v/v) | Day | Nitrogen | Carbon | Ratio | (mmhos/cm) | (MPN/gDWS) |
| 2:1 | 13 | 1.1% | 9.0% | 8.5 | 13.5 | ND^{†} |
| | 26 | 0.9% | 9.3% | 10.5 | 12.2 | <10 |
| | 44 | 0.9% | 8.9% | 9.7 | 12 | <10 |
| 3:2 | 13 | 0.9% | 8.6% | 9.4 | 12.8 | ND |
| | 26 | 0.9% | 9.0% | 10 | 13 | <10 |
| 1:1 | 13 | 0.9% | 9.2% | 10.8 | 16.6 | ND |
| | 26 | 0.8% | 8.1% | 10.8 | 13.1 | <10 |

^{†}Not done

relatively high amounts of nitrogen in the kitchen waste at the start of the study. During the course of the study, the carbon/nitrogen ratio remained relatively constant (see Table 4). In previous co-composting studies using yard wastes mixed with NVS, during the course of the studies the conductivity of the reaction mixtures were shown to change in a predictable manner and reflected the relative activity of the composting reaction. Initial conductivity readings typically were low, the breaking down of the vegetative matter then led to an increase in the conductivity of the reaction, followed by a decrease in the conductivity as the digested materials were utilized into the formation of biomass. Such changes were not observed in the reaction mixtures used in this study. One reason for this difference may be due to the relatively high conductivity readings at the start of the study. While the predicted changes in conductivity, used to determine the relative maturity of the co-composted material, were not apparent, the aging of the co-composting reaction was shown to be complete due to the stability of the volatile organics over the last segment of the reaction time (day 60-90).

The results show, in conclusion, that the two separate processes examined in these studies demonstrate three very different effective means to stabilize organic kitchen wastes. The first method used an industrial by-product (cement kiln dust) to alkaline stabilize the organics and odor generation in the organic kitchen wastes material. This process generated a product that was very suitable from both physical characteristics (the product remained granular and would tend to stack and be land applied easily) and pathogen reduction (easily achieving Class B. biosolids fecal coliform levels of less than 2×10⁶ MPN/gDWS). The second method utilized a laboratory model of the N-Viro Soil Process (52-62° C. for 12-18 hours, pH >12 for 72 hours, solids >50%) to pasteurize and stabilize the kitchen waste material and produce a Class A biosolids material. The third method used pre-formed NVS to facilitate the co-composting of the kitchen waste material and generate a product that, given the extent of the composting action, would be Class A with stabilized nutrients and significantly decreased odor, hence increased public acceptance. All three of these products have characteristics that could make them safe from a public health viewpoint and suitable for beneficial re-use, given the appropriate commercial application.

De-watered kitchen waste herein termed “kitchen waste cake” having 40% w/w solids was mixed with (a) a 20% w/w low-dose cement kiln dust (CKD) and (b) a 34% w/w high-dose CKD.

The components were blended in admixture for 2 minutes and allowed to cure for up to 72 hours.

The starting sample cake and resultant beneficial kitchen waste mixture products were evaluated for pH, solids content, volatile solids content, physical characteristics and odor.

The low-dose mixture was stored initially at ambient temperature of 22° C. before undergoing pasteurization, while the high-dose sample was treated and controlled at 54° C. for 18 hours, followed by 3 days of air drying.

The resultant products were also evaluated for agronomic value of macronutrients, NKP and CCE (calcium carbonate equivalent) and fecal coliforms. The results are shown in the Table.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A method of producing a beneficial source separated organics waste mixture, which method comprises mixing source separated organics waste cake and an effective amount of alkaline dust to form a composite mixture having a pH of at least 12 for at least 72 hours at a temperature selected from 52-62° C. for at least 12 hours; and collecting an initial said beneficial source separated organics waste mixture.

2. A method as defined in claim 1 wherein said source separated organics waste cake is kitchen waste cake.

3. A method as defined in claim 1 wherein said initial beneficial source separated organics waste mixture is stored for a further period of time selected from 10 hours to at least 70 hours to produce a final beneficial product.

4. A method as defined in claim 3 wherein said initial beneficial source separated organics waste mixture is kitchen waste mixture.

5. A method as defined in claim 1 wherein said alkaline dust is selected from cement kiln dust and lime kiln dust.

6. A method as defined in claim 2 wherein said alkaline dust is selected from cement kiln dust and lime kiln dust.

7. A method as defined in claim 1 wherein said beneficial kitchen waste mixture has a dryness of at least 55% w/w solids.

8. A method as defined in claim 2 wherein said beneficial kitchen waste mixture has a dryness of at least 55% w/w solids.

9. A method as defined in claim 3 wherein said beneficial kitchen waste mixture has a dryness of at least 55% w/w solids.

10. A method of treating source separated organics waste cake containing odorous material, animal viruses, pathogenic bacteria and parasites to provide a fertilizer which can be applied directly to agricultural lands, which method comprises the following steps of:
mixing said source separated organics waste cake with at least one alkaline material selected from the group consisting of lime, cement kiln dust and lime kiln dust to form a mixture wherein the amount of added alkaline material mixed with said cake is sufficient to raise the pH of said mixture to 12 and above for at least 72 hours;
drying said mixture to produce a granular material; and
wherein the amount of added alkaline material mixed with said cake and the length of time of drying said mixture is sufficient to (i) reduce significantly offensive odor of the cake to a level that is tolerable; (ii) reduce enterovirus therein to less than one plaque forming unit per 4 g dry-weight solids (DWS) of the cake; (iii) reduce fecal coliform bacteria therein to less than 1000 MPN per 1 g DWS; (iv) reduce salmonella to less than 3 MPN per 4 g DWS; (v) reduce parasites therein to less than one viable egg per 1 g DWS; (vi) reduce vector attraction to the cake; and (vii) prevent significant regrowth of the pathogenic microorganisms.

11. A method as claimed in claim 10 wherein said source separated organics waste is kitchen waste.

12. A method as defined in claim 10 wherein the amount of added alkaline material mixed with the cake and the length of time of drying is sufficient to reduce the odor to a level that is tolerable in a closed room even though the pH may drop below 9 during the drying, and maintain that odor control indefinitely even though said mixture is exposed to climatic conditions.

13. A method as defined in claim 11 wherein the amount of added alkaline material mixed with the cake and the length of time of drying is sufficient to reduce the odor to a level that is tolerable in a closed room even though the pH may drop below 9 during the drying, and maintain that odor control indefinitely even though said mixture is exposed to climatic conditions.

14. A method as defined in claim 12 wherein the added alkaline material comprises 35% w/w kiln dust.

15. A method as defined in claim 13 wherein the added alkaline material comprises 35% w/w kiln dust.

16. A method as defined in claim 10 wherein said drying is by aeration.

17. A method as defined in claim 11 wherein said drying is by aeration.

18. A beneficial source separated organics waste mixture product made in accordance with the method as defined in claim 1.

19. A beneficial source separated organics waste mixture product as defined in claim 18 being a kitchen waste mixture product.

20. A method of improving the workability and enhancing the macronutrient content of soil, said method comprising treating said soil with an effective amount of a beneficial source separated organics waste mixture product as defined in claim 18.
